(19) United States
(12) Patent Application Publication
(10) Pub. No.: US 2025/0008922 A1
(43) Pub. Date: Jan. 9, 2025

(54) DISPENSER, FEEDER AND SYSTEM FOR DISPENSING FEED

(71) Applicant: TECNIPLAST S.P.A., Buguggiate (IT)

(72) Inventors: Giovanni MALNATI, Malnate (IT); Marco Giovanni Antonio Brocca, Tradate (IT); Giovanni Frangelli, Caronno Varesino (IT)

(21) Appl. No.: 18/762,039

(22) Filed: Jul. 2, 2024

(30) Foreign Application Priority Data
Jul. 6, 2023 (IT) 102023000014097

(51) Int. Cl. A01K 5/02; A01K 1/03

(52) U.S. Cl. CPC A01K 5/0258; A01K 1/031

(57) ABSTRACT

A dispenser for dispensing feed, which comprises a container which is configured to contain feed and is provided with an inlet opening for loading feed into the container and an outlet opening for dispensing feed contained in the container, wherein an auger is arranged at the outlet opening and is mechanically connected to a rotor which is arranged in the container and is configured to be mechanically connected to an actuator to rotate the auger around a rotation axis. The present description also concerns a feeder and a system which can comprise said dispenser.

This application claims priority to Italian Patent Application No. 102023000014097, filed Jul. 6, 2023, which is hereby incorporated by reference in its entirety.

### TECHNICAL FIELD

The present description concerns a dispenser for dispensing feed, in particular to laboratory animals housed in laboratory containers, such as cages or tanks. The present description also concerns a feeder and a system which can comprise said dispenser.

### BACKGROUND OF THE DESCRIPTION

U.S. Pat. No. 8,449,719 describes a system for dispensing feed, wherein a mobile feeder can tip a dispenser containing feed around a horizontal axis from a horizontal position of the dispenser to an inclined position, so as to cause an amount of feed to fall by gravity into a container for animals. The amount of feed dispensed by the feeder with one rotation of the dispenser is determined by the speed of tipping of the dispenser and the feed contained in the dispenser cannot be completely emptied due to the structure of the dispenser and its arrangement in the feeder.

WO 2023/064428 A1 describes a similar system, wherein the mobile feeder rotates a dispenser around its longitudinal axis, which is arranged horizontally, so that an amount of feed is dispensed from a side opening of the dispenser due to the rotation of the dispenser. The dispensing precision is relatively low as it is difficult to dose the amount of feed that is dispensed from the side opening.

KR 100620535 B1 describes a feeder for dispensing feed, which comprises a feed dispenser and an actuator mechanically coupled with a rotor of the dispenser that is provided with an auger for dispensing feed through an outlet opening. Said dispenser and in particular its outlet opening are arranged above the actuator, so this known feeder cannot be easily used in a system for dispensing feed such as those described in U.S. Pat. No. 8,449,719 and WO 2023/064428 A1. Furthermore, the dispenser cannot be quickly and easily coupled or uncoupled with/from said known feeder, for example to replace the dispenser with another dispenser containing a different feed, due to screws that are used as coupling means.

RU 2676552 C1 and GB 1562486 A describe feeders comprising a feed dispenser which is stably fixed in the relevant feeder, so that also in these known feeders it is impossible or in any case difficult to replace a dispenser with another dispenser.

### SUMMARY OF THE DESCRIPTION

The object of the present description is therefore to provide a system that solves these problems. This object is achieved with a dispenser, a feeder and a system, the main features of which are specified in the attached claims, to be considered an integral part of the present description.

Thanks to the particular features of the dispenser and/or feeder, the system according to the present description allows feed to be dispensed in a more precise, faster and cleaner manner than known systems, as the dispensing of the feed does not require the movement of the entire dispenser.

The dispenser preferably comprises a particular auger, a particular rotor and/or a particular hopper, the features of which further improve the dispenser's precision of dispensing and its complete emptying.

The dispenser can be manufactured, applied, removed and cleaned relatively quickly and easily, thus reducing cost, maintenance and operating time of the system. For this purpose, the dispenser and a dispenser holder of the feeder comprise reversible coupling means, such as for example a lid and a plate provided with magnets and other mechanical devices suitable to facilitate the application and removal of the dispenser from the dispenser holder.

The feeder preferably comprises particular devices, such as a movable support provided with one or more electric strikers and/or bidirectional electric stepper motors, which reduce dispensing times and prevent feed from accidentally falling from the dispenser and dirtying the surrounding environment.

The relatively tidy and compact structure of the feeder also allows two dispensers to be applied to the feeder, instead of just one, thus improving the efficiency and versatility of the system.

Therefore, thanks to the particular combination of features of the dispenser and the feeder, the system according to the present description is more reliable and more efficient than the known systems.

The system may also comprise particular devices to improve the safety of the movement of the feeder and the conservation of the feed contained in the dispenser.

### BRIEF DESCRIPTION OF THE DRAWINGS

Further advantages and features of the dispenser, the feeder and the system according to the present description will be evident to those skilled in the art from the following detailed description of some embodiments, to be considered non-limiting examples of the claims, with reference to the attached drawings in which:

FIG. 1 is an exploded view of one embodiment of the dispenser;

FIG. 2 is a rear view of the dispenser of FIG. 1;

FIG. 3 is the (partial) section III-III of FIG. 2;

FIG. 4 is a perspective view of the dispenser of FIG. 1;

FIG. 5 is a perspective view of the dispenser of FIG. 1 with the respective dispenser holder;

FIG. 6 is a side view of the dispenser of FIG. 5;

FIG. 7 is section VII-VII of FIG. 6;

FIG. 8 is a perspective view from above of one embodiment of the feeder;

FIG. 9 is a perspective view from below of the feeder of FIG. 8;

FIG. 10 is a rear view of the feeder of FIG. 8;

FIG. 11 is a front view of the feeder of FIG. 8;

FIG. 12 is a bottom view of the feeder of FIG. 8;

FIG. 13 is a side view of the feeder of FIG. 8;

FIG. 14 is a side view of the feeder of FIG. 8 in a retracted position;

FIG. 15 is section XV-XV of FIG. 13;

FIG. 16 is section XVI-XVI of FIG. 13;

FIG. 17 is a front view of an embodiment of the system.

### EXEMPLARY EMBODIMENTS

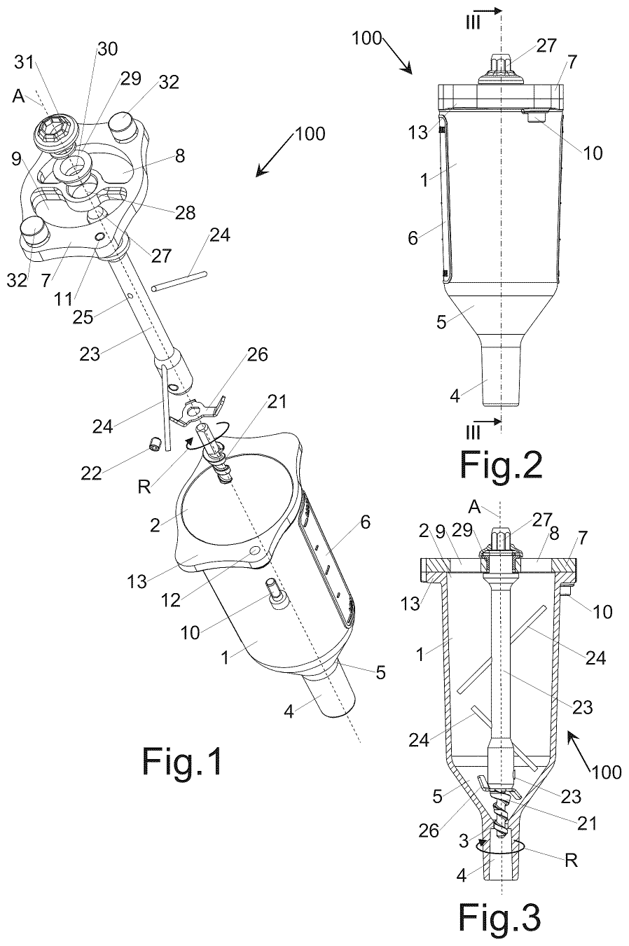

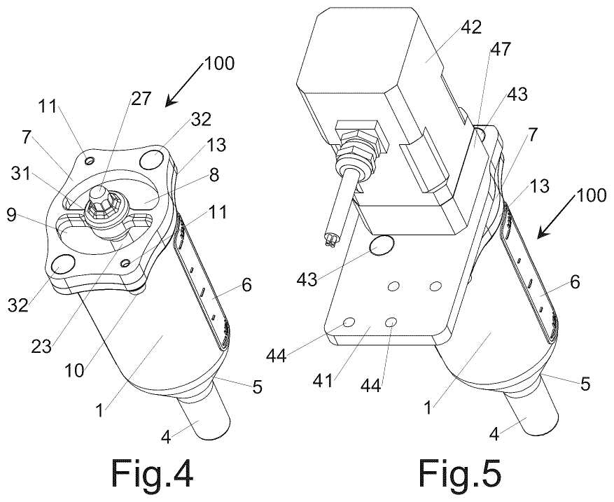

FIGS. 1-4 show an embodiment of the dispenser 100, which comprises a container 1 which is configured to contain feed and is provided with an inlet opening 2 for loading the feed into the container 1 and with an outlet opening 3 to dispense the feed contained in the container 1. The container 1 can also be provided with an outlet duct 4 arranged downstream of the outlet opening 3 to guide outwards the feed dispensed from the outlet opening 3. The outlet opening 3 is therefore located between the container 1 and the outlet duct 4. A hopper 5 is preferably arranged between the outlet opening 3 and the container 1 to convey the feed from the container 1 to the outlet opening 3. A side surface of the container 1 may comprise a transparent graduated scale 6 to show the quantity of feed contained in the container 1.

The inlet opening 2 of the container 1 can be partially or completely closed by a lid 7. The lid 7 preferably comprises one or more auxiliary openings 8, 9 in communication with the inlet opening 2 for loading the feed into the container 1 through the lid 7 also when the container 1 is closed by the lid 7. The lid 7 can be fixed to the container 1 by means of one or more screws 10 inserted into respective holes 11, 12 obtained in the lid 7 and in a flange 13 which is arranged around the inlet opening 2 of container 1.

Preferably, the hopper 5 has a substantially frustoconical shape and the container 1 has a substantially cylindrical or frustoconical shape. The container 1, the outlet duct 4, the hopper 5 and/or the flange 13 are preferably made of a single piece of molded plastic, in particular transparent polycarbonate.

An auger 21 is arranged at the outlet opening 3 of the container 1 and is mechanically connected to a rotor 23 arranged in the container. The auger 21 is arranged in the outlet opening 3 and/or projects from both sides of this opening. In particular, the rotor 23 comprises a substantially cylindrical shaft having one end keyed to the auger 21 by means of a grub screw 22. The rotor 23 is configured to be mechanically connected to an actuator to transmit a driving torque to the auger 21 and rotate the auger 21 around a rotation axis A, in particular an axis substantially coinciding with the longitudinal axis of the auger 21, in a direction of rotation R, to dispense feed with the auger 21 from the container 1, and preferably also in the direction opposite to the direction of rotation R, to move feed with the auger 21 towards the container 1.

Preferably, the auger 21 is frustoconical and/or with a larger diameter of 10-15 mm and/or with a smaller diameter of 5-10 mm. The outlet opening 3 is substantially cylindrical and/or with a diameter of 5-15 mm. Preferably, the free end of the auger 21 protrudes into the outlet duct 4 and/or the end of the auger 21 connected to the rotor 23 protrudes into the hopper 5. Preferably, the thread of the auger 21 has a substantially square section and/or the pitch of this thread increases towards the free end of the auger 21, i.e. towards the outside.

The rotor 23 may comprise one or more stirrers 24, in particular pins which are inserted into through holes 25 obtained in the rotor 23 and which form an angle of less than 90° with the rotation axis A, in particular an angle of 30°-60°. The rotor 23 may also comprise a propeller 26, in particular arranged adjacent to the auger 21. The propeller 26 comprises one or more blades, in particular three blades, wherein a distal portion of each blade forms with the rotation axis A an angle less than 90°, in particular an angle of 30°-60°. In particular, the propeller 26 is arranged in the hopper 5, wherein preferably distal portions of the blades of the propeller 26 are facing towards the side of the container 1 and are substantially parallel to the adjacent portion of the internal surface of the hopper 5, or are facing towards the side of the auger 21 and are substantially perpendicular to the adjacent portion of the internal surface of the hopper 5. Preferably, the container 1, the outlet duct 4, the hopper 5, the auger 21, the rotor 23 and/or the propeller 26 are mutually arranged in a substantially coaxial manner on the rotation axis A.

An end of the rotor 23 opposite to the end connected to the auger 21 preferably protrudes from the container 1, in particular from the lid 7, and/or comprises a head 27 configured to be coupled mechanically and preferably in a self-centering manner with a joint that can be driven by the actuator, so that the torque generated by the actuator can be transmitted to the auger 21 through this joint, the head 27 and the rotor 23. The head 27 is preferably made in one piece with the rotor 23 and has a polygonal shape with a tapered free end. The lid 7 preferably comprises a hub 28 which houses a portion of the rotor 23 in a rotatable and non-axially sliding manner, in particular by means of a bearing 29 and a retaining ring 30, which are covered by a cover 31 having a substantially frustoconical/frustopyramidal shape. The dispenser 100 preferably comprises reversible coupling means, in particular one or more magnets 32 comprised in the lid 7, which are configured to removably apply the dispenser 100 to a dispenser holder. Alternatively or in addition to the magnets 32, the reversible coupling means can comprise a mechanical rotary coupling, in particular a screw or bayonet coupling, which is configured to be rotated around the rotation axis A to achieve the coupling or decoupling with a dispenser holder.

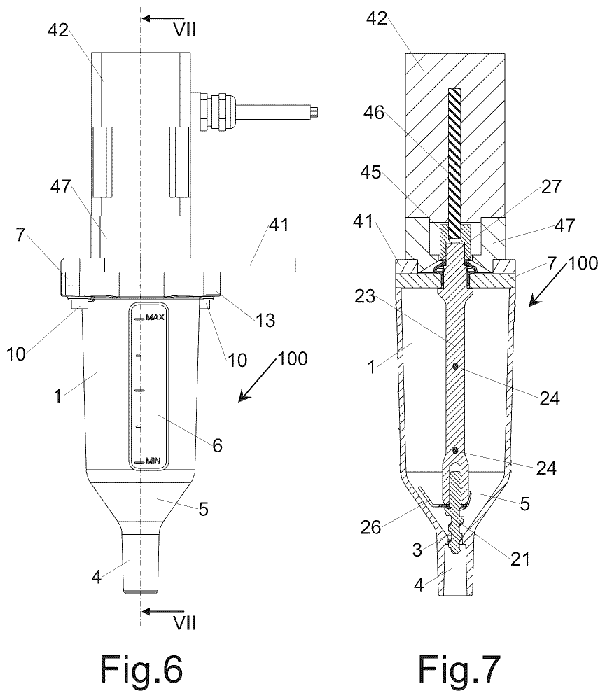

FIGS. 5-7 show the dispenser 100 of FIGS. 1-4 when it is fixed to a dispenser holder 41, in particular comprising a shaped plate, which supports an actuator 42, so that the dispenser holder 41 is arranged between the actuator 42 and the dispenser 100. Also the dispenser holder 41 can comprise reversible coupling means, in particular one or more magnets 43 and/or a rotary coupling, which are configured to cooperate with reversible coupling means of a dispenser, in particular the magnets 32 and/or a rotary coupling of the dispenser 100. For this purpose, the magnets 43 are arranged with reversed polarities to facilitate union with the adjacent magnets 32. Therefore, the dispenser 100 can be applied in a removable from the dispenser holder 41 or removed from the dispenser holder 41 by pushing, pulling, rotating and/or tilting the dispenser 100 with respect to the dispenser holder 41 with a manual action of an operator, in particular an action performed with a single hand, preferably a toolless action. The dispenser holder 41 can comprise one or more holes 44 for fixing with screws the dispenser holder 41 to a feeder for dispensing feed. During the coupling of the dispenser 100 with the dispenser holder 41, the head 27 mechanically and automatically couples with a joint 45 which can be rotated by the actuator 42. As shown in the figures, in its operating position, the joint 45 is arranged under the actuator 42, so that the dispenser 100 is arranged under the dispenser holder 41 when the dispenser 100 is mechanically coupled with the dispenser holder 41. The actuator 42 preferably comprises an electric stepper motor configured to rotate in both directions of rotation a drive shaft 46 which is mechanically connected to the joint 45 to in turn rotate in both directions, if desired, a dispensing device, in particular the auger 21 of the dispenser 100 fixed to the dispenser holder 41. The actuator 42 preferably comprises an adapter 47 configured to accommodate the joint 45 and to fix the electric motor to the dispenser holder 41.

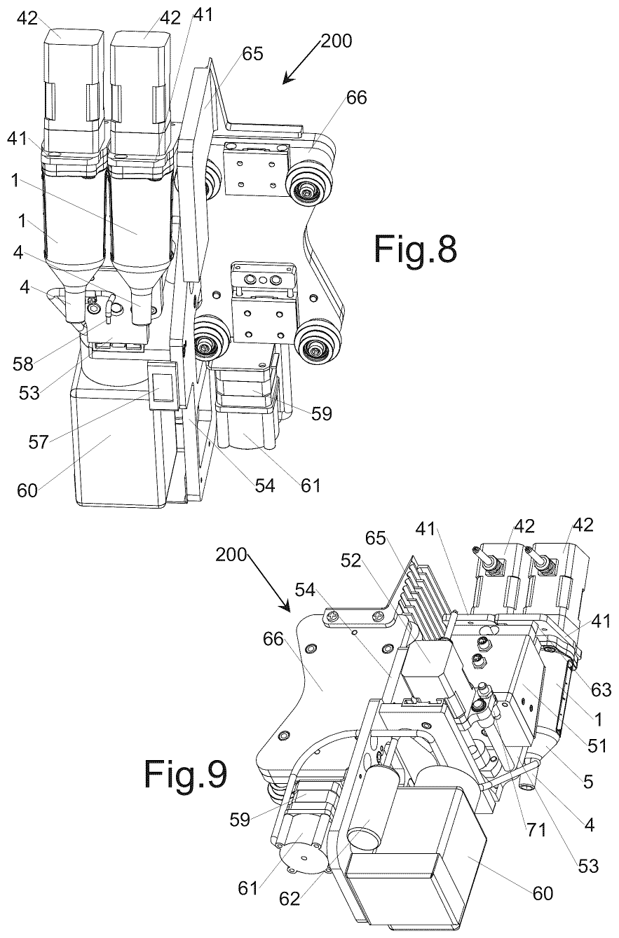

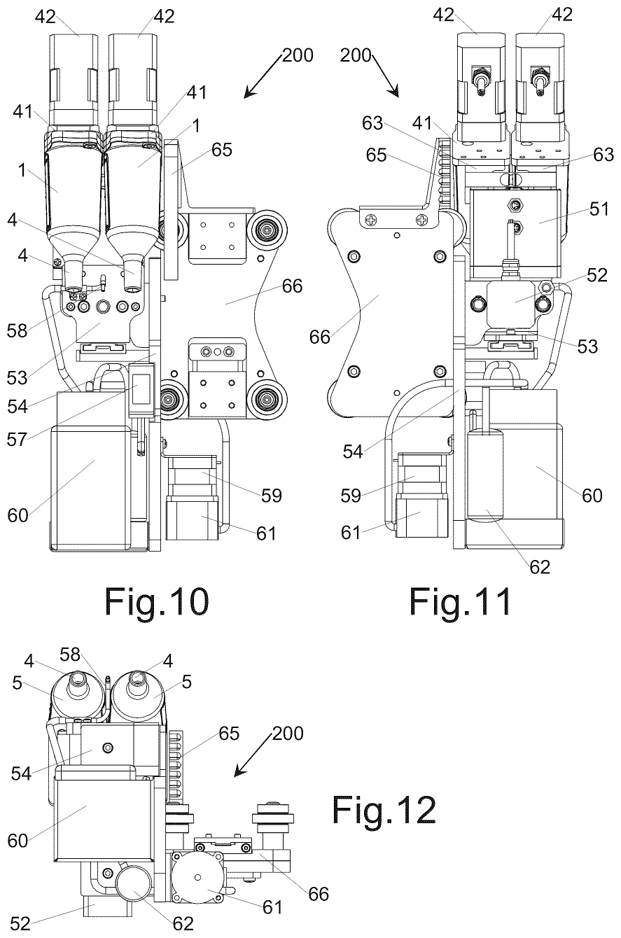

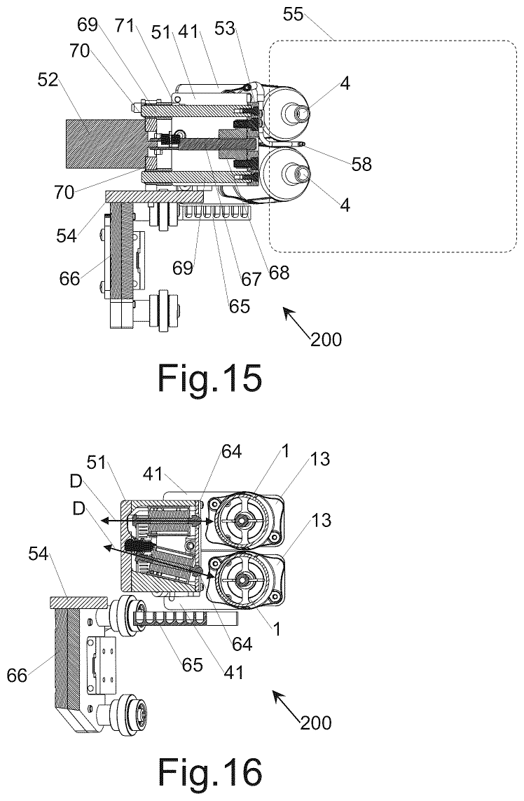

FIGS. 8-16 show an embodiment of the feeder 200 which can comprise a dispenser, in particular two dispensers 100 according to the embodiment described above, which are arranged with the rotation axes A substantially parallel to each other. The feeder 200 also comprises a dispenser holder, in particular two dispenser holders 41 fixed to a movable support 51 which can be moved by an actuator 52, in particular an electric actuator. For this purpose, the movable support 51 is fixed to a slide 53 configured to be moved by the actuator 52 back and forth with respect to a frame 54 of the feeder 200 in a direction Z from an extended position to a retracted position, and vice versa. Preferably, the movable support 51 can move with respect to the frame 54 only in the direction Z.

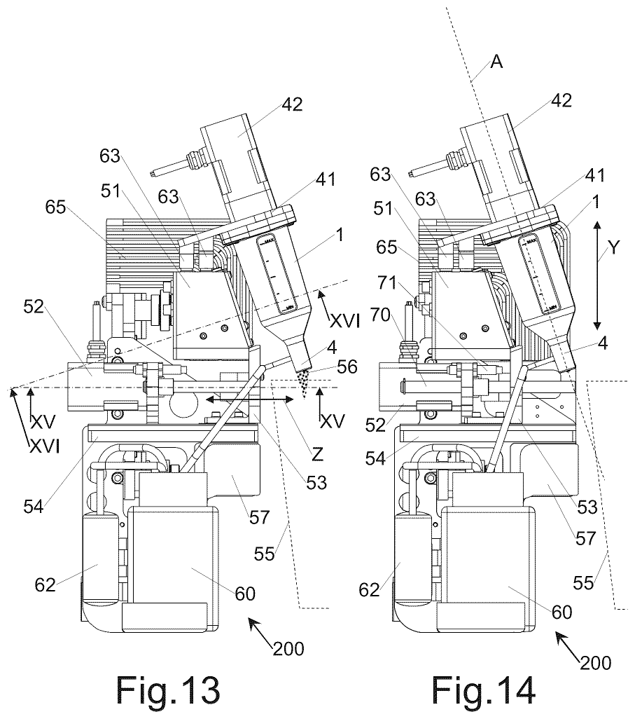

In the extended position of the movable support 51, shown in FIG. 13, a dispenser fixed to the respective dispenser holder 41 can protrude outwards and onto a container 55 (shown with dotted lines), in particular a cage or tank for laboratory animals, so that feed 56 contained in the dispenser can be dispensed into the container 55 by activating the respective actuator 42, in particular by rotating the auger 21 of the dispenser 100.

In the retracted position of the movable support 51, shown in FIG. 14, a dispenser fixed to a dispenser holder 41 does not protrude outwards, so the feeder 200 can be moved vertically in the direction Y with respect to the container 55 without interfering with said dispenser.

Each dispenser holder 41 is preferably oriented in the feeder 200 so that the rotation axis A of the dispenser 100 fixed to it is inclined with respect to the Y direction, i.e. to a substantially vertical direction in the position of use of the feeder, with an angle of 10°-25°, in particular 15°-20°, i.e. inclined with respect to the direction Z of the movement of the movable support 51 with an angle of 65°-80°, in particular 70°-75°.

The feeder 200 may also comprise an optical reader 57 which is fixed to the frame 54 under the movable support 51 and is configured to read a label applied to the container 55. The feeder 200 may also comprise a spout 58 which is fixed to the movable support 51 and is connected to a pump 59 which is in turn connected to a tank 60 filled with liquids, for example nutrients for laboratory animals, and can be driven by a motor 61. An aerator 62 may be connected to the tank 60 to aerate the liquids contained in it. The spout 58 is preferably arranged beside an outlet duct of a dispenser, in particular between the outlet ducts 4 of the two dispensers 100.

Each dispenser holder 41 is preferably fixed to the movable support 51 via a load cell 63 to weigh the dispenser 100, in particular the dispensed quantity of feed 56. The movable support 51 preferably comprises one or more electric strikers 64 configured to strike one or several times a dispenser, in particular the container 1 of a dispenser 100, during or after the dispensing of the feed 56 into the container 55, in particular in a direction D substantially perpendicular to the axis of rotation A of the dispenser 100. The feeder 200 may comprise a cable guide 65 fixed to the frame 54 to guide electrical cables (not shown in the figures) of the actuator 52, the optical reader 57, the motor 61 and the electric strikers 64. The feeder 200 may also comprise a cart 66 fixed to the frame 54 to guide the movement of the feeder in the direction Y. The actuator 52 is preferably configured to rotate a screw 67 engaged in a threaded bushing 68 fixed to the slide 53, so that the actuator 52 moves the slide 53 forward or backwards in the direction Z by rotating the screw 67 in one direction or the opposite direction. The slide 53 may comprise one or more pins 69 which are substantially parallel to the direction Z and can slide in perforated guides 70 fixed to the frame 54. A position sensor 71 may be arranged between the actuator 52 and the slide 53 to detect the position of the slide 53 compared to the frame 54.

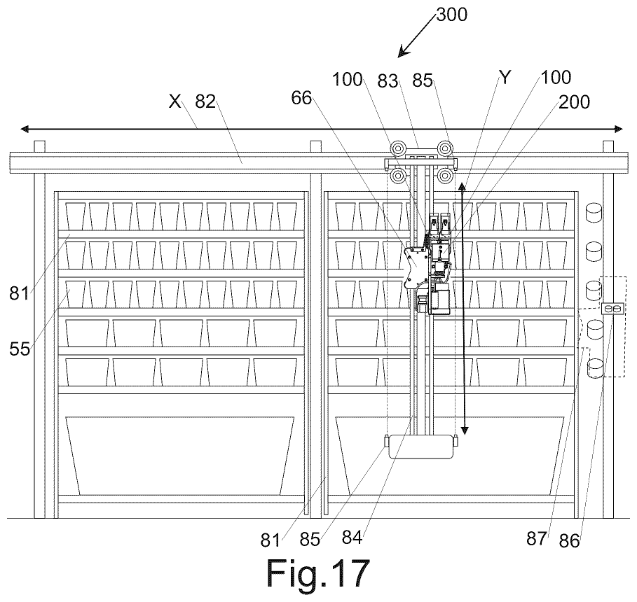

FIG. 17 shows an embodiment of the system 300, which can comprise a dispenser, in particular two dispensers 100 according to the present description and/or a feeder, in particular a feeder 200 according to the present description. Furthermore, the system 300 may comprise transport means for moving a feeder 200 in the direction X, i.e. a substantially horizontal direction, and/or in the direction Y, i.e. a substantially vertical direction, so that this feeder can dispense feed, preferably by one or more dispensers 100 according to the present description, in a given animal container of a plurality of animal containers 55 arranged in several rows and/or columns. For this purpose, the containers 55 are arranged on one or more shelves 81. Said transport means may comprise a horizontal rail 82 for a cart 83 which can slide along the direction X, and/or a vertical rail 84 for a cart which can slide along the direction Y, in particular the cart 66 of the feeder 200 according to the present description. The vertical rail 84 may be fixed to the cart 83 to slide along the X direction.

The transport means of the system may comprise one or more proximity sensors 85 configured to stop the movement of the feeder 200 if they detect an obstacle. In particular, the proximity sensors 85 are fixed to the cart 83 and/or to the vertical rail 84 to detect the presence of an obstacle, for example an operator who is picking up a container 55, during the movement of the vertical rail 84 in the direction X.

The system may also comprise a rest station 86 for the feeder 200, which is arranged in a rest position 87 (shown with dashed lines) in the area covered by the movement of the feeder 200 in the direction X and/or in the direction Y. The rest station 86 is provided with one or more elastomeric shutters configured to close by interference the outlet opening 3 (in the absence of the outlet duct 4) or the outlet duct 4 of a dispenser, in particular the dispenser 100 described above, which is coupled with the dispenser holder 41 of the feeder 200. The elastomeric shutters can therefore act as plugs to prevent, for example, the entry of humidity into the container 1, if the dispensers 100 are extended by the feeder 200 at the elastomeric shutters of the rest station 86.

The system may further comprise electromechanical drive means (not shown in the figures) for moving said carts 66, 83, as well as electronic control means for controlling the movement of the carts 66, 83 and devices of the feeder 200, in particular the actuators 42, 52, the motor 59 and/or the electric strikers 64, for example according to analog or digital signals obtained from sensors of the system 300, in particular from the optical reader 57, from the load cells 63 and/or from the position sensor 71 of the feeder 200, as well as from the proximity sensors 85.

Variants or additions can be made by those skilled in the art to the embodiments described and illustrated herein while remaining within the scope of the following claims. In particular, further embodiments may comprise the technical features of one of the following claims with the addition of one or more technical features described in the specification or illustrated in the drawings, taken individually or in any reciprocal combination and comprising their equivalent features.

Furthermore, the terms “a/an/one”, “two”, etc. in the description and claims respectively mean “at least one”, “at least two”, etc., unless otherwise specified. Similarly, angles, aspect ratios and values mentioned in the specification and/or shown in the drawings comprise a tolerance of at least 5%, unless otherwise specified.

1. A dispenser for dispensing feed, which comprises reversible coupling means, which are configured to removably apply the dispenser to a dispenser holder of a feeder for dispensing feed, and a container, which is configured to contain feed and is provided with an inlet opening for loading feed into the container and an outlet opening for dispensing feed contained in the container, wherein an auger is arranged at the outlet opening and is mechanically connected to an end of a rotor which is arranged in the container and is configured to be mechanically connected to an actuator fixed to the dispenser holder to rotate the auger around a rotation axis, wherein the rotor comprises a head configured to mechanically connect the rotor to the actuator, wherein the end of the rotor, which is opposite the end of the rotor connected to the auger, protrudes from the container and comprises said head.

2. The dispenser according to claim 1, wherein a hopper is arranged between the outlet opening and the container to convey feed from the container to the outlet opening, wherein the rotor comprises a propeller which is arranged in the hopper and comprises one or more blades, wherein distal portions of the blades of the propeller are facing the side of the container and are substantially parallel to the adjacent portion of the internal surface of the hopper, or are facing the side of the auger and are substantially perpendicular to the adjacent portion of the internal surface of the hopper.

3. The dispenser according to claim 1, wherein the auger is frustoconical and the thread of the auger has a pitch that increases towards the free end of the auger.

4. The dispenser according to one of claim 1, wherein the head of the rotor is configured to be coupled mechanically and in a self-centering manner with a joint which can be operated by the actuator fixed to the dispenser holder.

5. The dispenser according to claim 4, wherein the head of the rotor has a polygonal shape with a tapered free end.

6. The dispenser according to claim 1, wherein said reversible coupling means comprise one or more magnets and/or a mechanical rotary coupling configured to be rotated around the rotation axis of the auger to carry out the coupling or decoupling of the dispenser with the dispenser holder.

7. The dispenser according to claim 1, wherein the inlet opening of the container is partially or completely closed by a lid which comprises one or more magnets and a hub which houses a portion of the rotor in a rotatable and non-axially sliding manner.

8. A feeder for dispensing feed, which comprises at least one dispenser holder, which comprises reversible coupling means configured to cooperate with reversible coupling means of a dispenser for dispensing feed to mechanically couple the dispenser holder with the dispenser, as well as an actuator comprising a joint which can be rotated by the actuator and is configured to be mechanically connected to and rotate a head of a rotor of the dispenser when the dispenser is mechanically coupled with the dispenser holder, wherein the joint is arranged under the actuator, so that the dispenser is arranged under the dispenser holder when the dispenser is mechanically coupled with the dispenser holder.

9. A feeder for dispensing feed, which comprises at least one dispenser holder, which is mechanically coupled with a dispenser according to claim 1 and comprises reversible coupling means cooperating with the reversible coupling means of the dispenser to mechanically couple the dispenser holder with the dispenser, as well as an actuator comprising a joint which can be rotated by the actuator and is mechanically connected to the head of the rotor of the dispenser, wherein the joint is arranged under the actuator, so that the dispenser is arranged under the dispenser holder.

10. The feeder according to claim 8, wherein the actuator comprises an electric stepper motor configured to rotate in both directions of rotation.

11. The feeder according to claim 8, wherein the dispenser holder is mounted on a movable support configured to be moved by an actuator in a direction with respect to a frame of the feeder.

12. The feeder according to claim 11, wherein the dispenser holder is oriented in the feeder so that the rotation axis of the dispenser is inclined with respect to the direction of the movement of the movable support with an angle of 65°-80°, in particular 70°-75°.

13. The feeder according to claim 11, wherein the dispenser holder is fixed to the movable support via a load cell configured to weigh the dispenser coupled with the holder dispenser.

14. The feeder according to claim 11, wherein the movable support comprises one or more electric strikers configured to strike the dispenser one or more times.

15. A system for dispensing feed into a container for animals, which system comprises a feeder according to claim 8, as well as transport means for moving the feeder in a substantially horizontal direction and/or in a substantially vertical direction.

16. The system according to claim 15, wherein the transport means comprise one or more proximity sensors configured to stop the movement of the feeder if they detect an obstacle.

17. The system according to claim 15, wherein a rest station for the feeder is arranged in a rest position in the area covered by the movement of the feeder in the substantially horizontal direction and/or in the substantially vertical direction and is provided with one or more elastomeric shutters configured to close by interference the outlet opening or an outlet duct of a dispenser coupled with the dispenser holder of the feeder.

18. A system for dispensing feed into a container for animals, which system comprises a feeder according to claim 9, as well as transport means for moving the feeder in a substantially horizontal direction and/or in a substantially vertical direction.
